(19) United States
(12) Patent Application Publication
(10) Pub. No.: US 2007/0251550 A1
(43) Pub. Date: Nov. 1, 2007

(54) Handheld Rotary Tool Driven by Water Turbine

(76) Inventors: Dirk Leon Erasmus, Rustenburg (ZA); Leon Erasmus, Rustenburg (ZA)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/632,876

(22) PCT Filed: Jul. 20, 2005
(86) PCT No.: PCT/IB05/02095

§ 371 Date: Jan. 19, 2007

(30) Foreign Application Priority Data
Jul. 20, 2004 (ZA) 2004/5776

(51) Int. Cl. F03B 13/00

(52) U.S. Cl. 134/33; 134/123

(57) ABSTRACT

The invention provides a handheld rotary accessory (10) which includes an accessory body (12), and a water driven turbine (16) mounted on the accessory body (12); the water driven turbine (16) having a turbine wheel (20) mounted for rotation about a turbine wheel rotational axis (22), and having a plurality of circumferentially spaced turbine wheel blades (46) each of which has a radially inner edge and a radially outer edge. The accessory (10) also includes a turbine feed water arrangement which includes a feed water inlet (18) which is connectable to a pressurised water supply and a nozzle (50) connected in flow communication with the feed water inlet (18), the nozzle (50) being positioned radially inwardly of the radially inner edges of the blades (46). The invention extends to a method of rotatably driving a utility accessory which forms part of a handheld rotary accessory.

THIS INVENTION relates to fluid driven rotary accessories. In particular, the invention relates to a handheld rotary accessory. The invention also relates to a method of rotatably driving a utility accessory which forms part of a handheld rotary accessory.

The invention provides a handheld rotary accessory which includes:
an accessory body;
a water driven turbine mounted on the accessory body; the water driven turbine having a turbine wheel mounted for rotation about a turbine wheel rotational axis, and having a plurality of circumferentially spaced turbine wheel blades each of which has a radially inner edge and a radially outer edge; and
a turbine feed water arrangement which includes a feed water inlet which is connectable to a pressurised water supply and a nozzle connected in flow communication with the feed water inlet, the nozzle being positioned radially inwardly of the radially inner edges of the blades.

The water turbine may include a turbine housing defining a turbine housing cavity and an exhaust aperture, positioned radially outwardly of the turbine wheel blades, towards which the nozzle is directed.

In one embodiment of the invention, the turbine housing includes two opposite parallel spaced apart major side panels, one major side panel being a circular side panel and the other major side panel being an annular side panel, and a turbine housing edge extending between the radially outer peripheries of the major side panels, the exhaust aperture being defined in the turbine housing edge.

The accessory body may include an elongated handle having a distal end and a proximal end, the water driven turbine being mounted at the distal end of the elongated handle. The elongated handle may be circular cylindrical and have a flow passage extending therethrough for at least part of its length.

The turbine housing may be connected to the distal end of the handle, the handle projecting from an outside face of the circular side panel of the turbine housing at an acute angled inclination relative to the outside face of the circular side panel diametrically away from the exhaust aperture.

The turbine housing may also include turbine wheel mounting formations for mounting the turbine wheel for rotation about the turbine wheel rotational axis inside the turbine housing, which turbine wheel rotational axis extends between respective centers of the major side panels.

Typically, the turbine wheel comprises a turbine wheel shaft and a coaxially located annular turbine wheel back plate, the turbine wheel shaft projecting perpendicularly from the turbine wheel back plate, the turbine wheel shaft being fixedly mounted inside the turbine housing on the wheel mounting formations, the turbine wheel back plate being rotatably mounted on the turbine wheel shaft.

In another embodiment of the invention, the turbine wheel back plate and the turbine wheel shaft may be of unitary construction, in which case, the turbine wheel shaft is rotatably mounted inside the turbine housing.

The turbine wheel blades may be vanes which project generally perpendicular from one annular face of the turbine wheel back plate, each one of the vanes being curved at a predetermined radius of curvature. Instead, the turbine wheel blades are buckets which are circumferentially arranged in a concentric ring on one annular face of the turbine wheel back plate.

A coupling formation may be provided coaxially fast with the turbine wheel, a free end of the coupling formation projecting past a central opening of the major annular side panel of the turbine housing, the one end of the coupling formation being for engagement with an auxiliary driving arrangement.

The auxiliary driving arrangement may include a drive gear which is provided at the free end of the coupling formation, and a driven gear which is rotatably mounted on a driven gear support shaft which projects from an outside face of the annular major side panel. The driven gear may include a utility connection arrangement for connecting a utility accessory for rotation therewith to the driven gear. The drive gear to driven gear ratio may be between 1:2 and 1:4, preferably 1:3.

The utility accessory may be a brush comprising a circular brush back plate and bristles extending from one face of the brush back plate, the brush further having brush connection formations for cooperation with the utility connection arrangement of the driven gear.

The feed water inlet may be provided at the proximal end of the handle, and may be arranged for connection to a water hose which is connectable to the pressurised water supply.

The turbine feed water arrangement may include a water conduit for providing the feed water flow path from the feed water inlet to the feed water outlet. The flow passage may extend through the handle which forms part of the water conduit.

The accessory may include a water control valve in line with the water conduit for permitting a user to control the amount of turbine feed water flowing from the feed water inlet to the nozzle, consequently permitting the user to control the rotational speed of the turbine.

The accessory may further include a detergent feeding arrangement for discharging a detergent onto a surface which is to be cleaned, in use. The detergent feeding arrangement may include a detergent container defining a detergent cavity, a detergent water inlet, and a detergent discharge outlet.

The detergent container may be removably carried on the accessory body.

In a preferred embodiment of the invention, the detergent water inlet is in fluid communication with the water conduit, for permitting water to flow into the detergent cavity and to mix with the detergent. The detergent container may include an openable closure member for permitting access to the detergent cavity for refilling the detergent cavity with a detergent.

The detergent container may be arranged for receiving a water dissolvable detergent bar, the detergent container being shaped and sized to leave a workable gap between the detergent bar and an inside surface of a longitudinal wall of the container so that water entering the detergent container through the container water inlet flows over the detergent bar, to dissolve part of the detergent to form a detergent-water mixture which flows out of the detergent discharge outlet.

Conveniently, the detergent discharge outlet may be provided at the brush. In particular, the driven gear shaft may define a longitudinal shaft cavity having an opening at one end, which opening serves as the detergent discharge opening at the centre of the brush, the shaft cavity being in fluid communication with the detergent container cavity.

The detergent feeding arrangement may include a detergent feed valve which is installed inline the detergent flow path for permitting a user to control the flow of detergent through the detergent discharge outlet.

The invention also provides a method of rotatably driving a utility accessory which forms part of a handheld rotary accessory of the type having a water driven turbine having a plurality of circumferentially spaced blades drivingly connected to the utility accessory, which method includes discharging water from a nozzle positioned radially inwardly of the turbine blades onto the turbine blades.

The turbine may be positioned in a housing and the method may include exhausting water from the housing at a position radially outwardly of the blades.

A method of rotatably driving a utility accessory which forms part of a handheld rotary accessory, which method includes

providing an outward flow turbine on a body of the handheld rotary accessory;

mounting the utility accessory drivingly to the outward flow turbine; and

connecting a domestic water supply to a turbine feed water arrangement for supplying feed water to the outward flow turbine for driving the turbine.

The invention will now be described, by way of example, with reference to the accompanying diagrammatic drawings, in which:

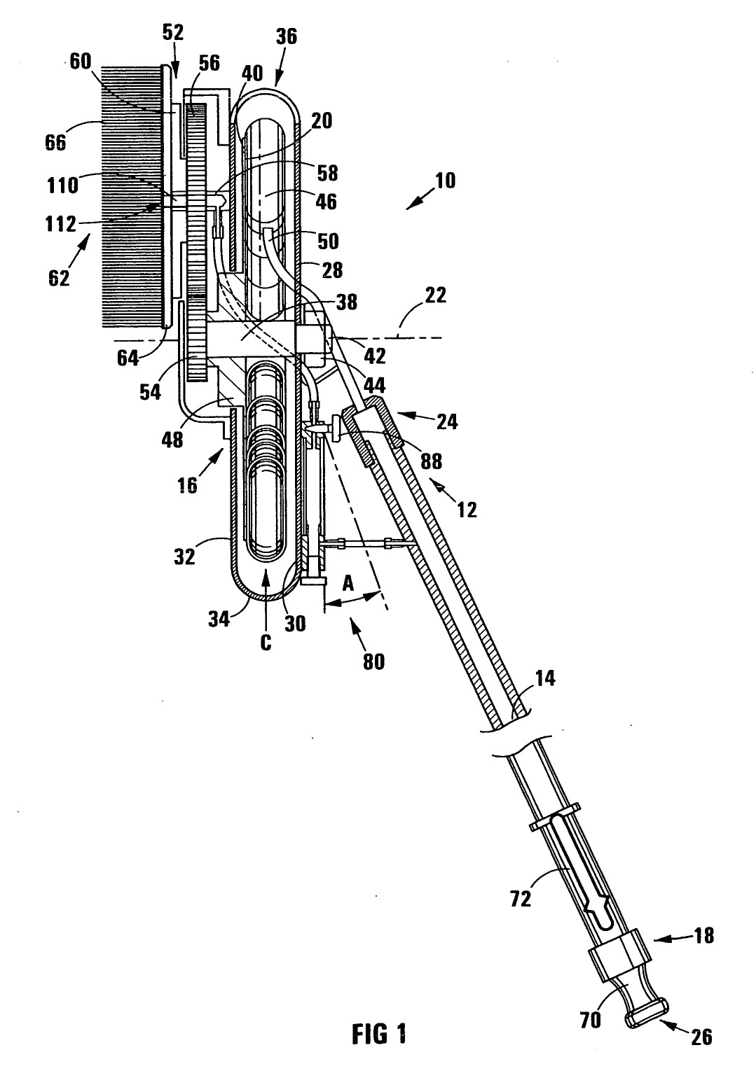

FIG. 1 is a partly sectioned elevation view from one side of a rotary accessory, in accordance with the invention;

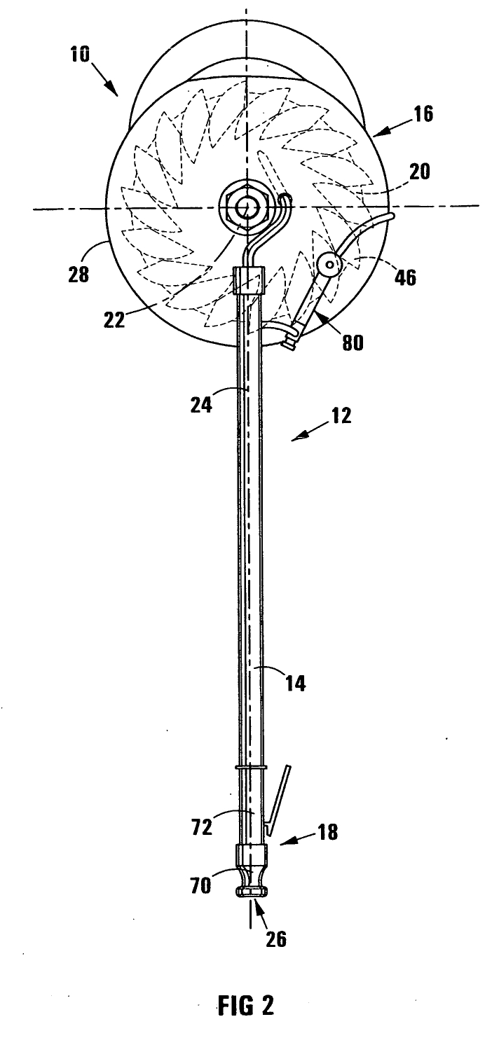

FIG. 2 is an elevation view from a rear side of the rotary accessory in FIG. 1;

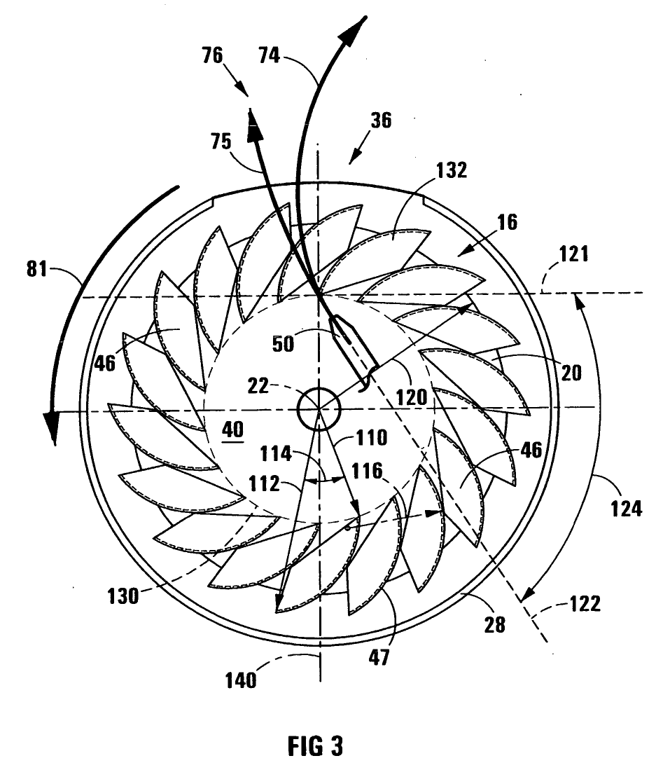

FIG. 3 is a partly sectioned elevation view from a front of part of the rotary accessory of FIG. 1, and

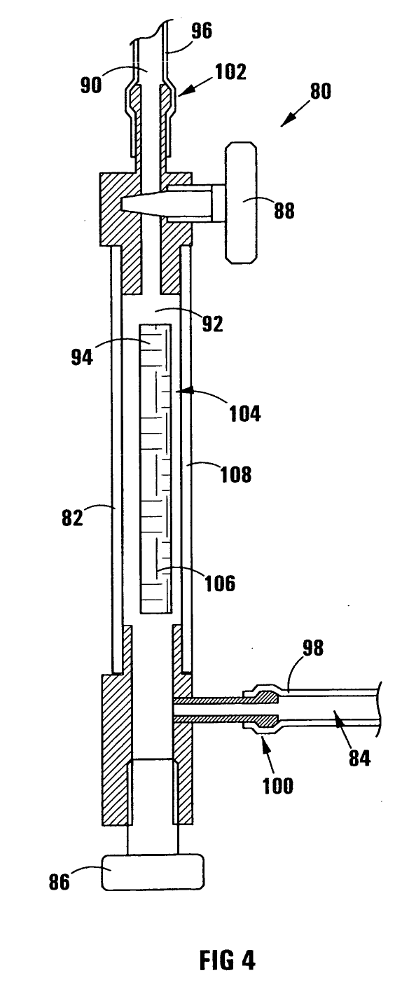

FIG. 4 is a partly sectioned elevational view of part of a detergent arrangement which forms part of the rotary accessory in FIG. 1.

In the drawings, a handheld rotary accessory, in accordance with the invention, is generally indicated by reference numeral 10.

The rotary accessory 10 includes an accessory body 12 comprising an elongate handle 14 and a water driven turbine 16 mounted on the elongate handle 14 The water driven turbine 16 has a turbine wheel 20 mounted for rotation about a turbine wheel rotational axis 22.

The rotary accessory 10 also includes a turbine feed water arrangement which comprises a feed water inlet, generally indicated by reference numeral 18, and a feed water outlet 50, connected in flow communication with the feed water inlet 18. The feed water inlet 18 is connectable to a domestic garden hose, in use, for supplying feed water to the water driven turbine 16, the feed water outlet 50 being for injection of a jet of water inside the water driven turbine 16 to drive the turbine wheel 20. The water outlet 50 is provided by a nozzle which is directed outwardly, thus constituting a turbine of the outward-flow type, as described in more detail below.

The handle 14 is tubular having a distal end 24 and a remote end 26.

The water driven turbine 16 includes a turbine housing 28 which is located at the distal end 24 of the handle 14. The turbine housing 28 defines a turbine housing cavity between two opposite parallel spaced apart major side panels, one being a circular side panel 30 and the other being an annular side panel 32. A turbine housing edge 34 extends between the radially outer peripheries of the major side panels 32, 34. An exhaust opening 36 is defined by the turbine housing edge 34.

The handle 14 projects from an outside face of the circular side panel 30 of the turbine housing 28 at an angle A relative to the outside face of the circular side panel 30 diametrically away from the exhaust opening 36.

In this example, the turbine housing 28 is provided with a fixed turbine wheel shaft 38 onto which an annular turbine wheel back plate 40 is rotatably mounted. The fixed turbine wheel shaft 38 has a cross-sectionally reduced screw threaded stub 42, which projects through a central opening defined by the circular major side panel 30. The screw threaded stub 42 and a threaded nut 44 constitute a turbine wheel mounting formation which is provided to secure the turbine wheel shaft 38 in position.

The turbine wheel back plate 40 is dimensioned so that a clearance, indicated by letter C, is provided between a radially outer edge of the turbine wheel back plate 40 and a radially inner surface of the turbine housing edge 34.

The turbine wheel 20 includes a plurality of equiangularly spaced turbine wheel blades 46 in the form of buckets, which are arranged in a circumferentially extending ring on one annular face of the back plate 40. In this embodiment of the invention, the circular turbine wheel 20 has a radius 120 of 100 mm. As is best seen in FIG. 3, each bucket 46 has a convex impact side wall 47 onto which the jet of water impinges, in use. The side wall 47 typically has a radius of curvature 116 of between 40 mm and 60 mm. In this embodiment of the invention, the radius 116 is 50 mm. Radial inner edges of the buckets lie on a pitch circle 130 having a radius 110 of 60 mm, and radial outer edges of the buckets 46 lies on a pitch circle having a radius of 115 mm. An included angle 114 between respective radial directions of arrows 110 and 112 is 21 degrees.

In another embodiment of the invention, the blades are provided by vanes which project generally perpendicular from the one annular face of the turbine wheel back plate 40, each one of the turbine wheel blades 46 being similarly curved at a predetermined radius of curvature.

In this example, a coupling formation 48 projects from the turbine wheel back plate 40, the coupling formation 48 being co-axial with the fixed turbine wheel shaft 38. The coupling formation 48 has a root end fixed to the turbine wheel back plate 40 and a free end which projects past a central opening of the annular side panel 32 of the turbine housing 16.

The nozzle 50 is positioned in an annular recess defined between the shaft 38 and the radially inner edges of the buckets 46. The nozzle 50 is directed outwardly generally tangential to the radially inner edge of a bucket 46 in register therewith and towards one edge of the aperture 36, i.e. that edge which is the trailing edge in the direction of rotation of the turbine wheel 20. With reference to FIG. 3, the nozzle 50 is positioned so that a direction of the jet of water coincides with line 122. Another line 121 is a line tangential to the pitch circle 130. In this embodiment of the invention, the instance when the inner edge of the bucket, see the bucket indicated by reference numeral 132, a center line 140 of the turbine wheel 20, and the line 122 coincides, an included angle 124 of 49 degrees is formed between the line 121 and 122. By way of development, the angle 124 can differ, typically between 47 degrees and 51 degrees.

The nozzle 50 is shaped and sized to provide an elongate nozzle outlet opening. The nozzle 50 is arranged so that a lengthwise direction of the nozzle opening is more or less perpendicular to the back plate 40, the nozzle producing a jet of water which is narrower than the width of the buckets 46.

The free end of the coupling formation 48 engages with an auxiliary driving arrangement 52 which forms part of the rotary accessory 10. The auxiliary driving arrangement 52 includes a gear set comprising a drive or pinion gear 54 provided at the free end of the coupling formation 48, and a driven gear 56. The driven gear 56 is rotatably mounted on a support shaft 58 which projects from an outside face of the annular major side panel 32.

The driven gear 56 is provided with an accessory connection arrangement 60. The accessory connection arrangement 60 can e.g. include clip-on type formations (not shown), to cooperate with complementary connecting formations provided on a utility accessory 62, for connection of the utility accessory 62, or other applicable utility accessories (not shown), to the driven gear 56 for rotation therewith. In this example the utility accessory 62 is in the form of a generally circular rotary brush, however, it may take another form, e.g. a sponge and the different accessories may be interchangeable.

The rotary brush 62 comprises a rotary brush back plate 64 and bristles 66 projecting from one face of the rotary brush back plate 64, the rotary brush 62 further having rotary brush connection formations to cooperate with the accessory connection arrangement 60 of the driven gear 56.

The feed water inlet 18 includes a domestic garden hose connecter 70 provided at the proximal end 26 of the handle 14. The domestic garden hose connecter 70 is typically a quick release connector similar to any one of the commercially available garden hose quick-release connectors typically used for connection of a domestic garden hose to a tap and to other gardening water tools.

The turbine feed water arrangement includes a passage extending through the handle 14, the passage forming part of a turbine feed water flow path from the feed water inlet 18 to the feed water outlet 50. An inline valve 72 is provided on the handle 14 for permitting a user to control the amount of turbine feed water flowing form the feed water inlet 18 to the feed water outlet 50.

The accessory 10 also includes a detergent feeding arrangement, generally indicated by reference numeral 80, for discharging a detergent or other water soluble substance onto a surface which is cleaned, in use. The detergent feeding arrangement 80 includes a detergent container 82 defining a detergent cavity 92. The detergent feeding arrangement also has a container water inlet 84 and a detergent discharge outlet 96.

The detergent container 82 is removably carried on the turbine housing 28, as is best seen in FIG. 1. The water inlet 84 includes a tube 98 which defines a water flow passage which is in fluid communication with the flow passage defined by the handle 14. This arrangement permits water to flow into the detergent cavity 92 to mix with a detergent inside the detergent cavity 92.

The container 82 is connected to the tube 98 by way of a quick release connection 100, at the inlet side of the container 82, and similarly by way of a quick release connection 102 to an outlet tube 96 at an outlet side of the container 82. Thus, the container 82 can be released from the respective inlet- and outlet tubes 98, 96 or replaced by another detergent container which is adapted for use with an associated detergent. In this embodiment, the container is elongated and tubular to receive a water dissolvable detergent bar or stick 106. The detergent container 82 is shaped and sized to leave a workable gap 104 between the detergent stick 106 and an inside surface of a side wall 108 of the container 84 so that water entering the detergent container 84 through the water inlet tube 98 can flow over the detergent stick 108 and out of the outlet tube 96. The water flowing over the detergent stick 108 will dissolve some of the detergent so that a detergent-water mixture flows out of the container outlet tube 96.

The detergent container 82 includes an openable closure member 86 for permitting access to the detergent cavity 92 for refilling the cavity 92 with a fluid detergent, or detergent bar, as the case may be.

The outlet tube 96 extends to the support shaft 58. The support shaft 58 defines a longitudinal flow passage 110 which opens at 112, and a side wall opening for connecting the outlet tube 96 in fluid communication with the flow passage 110. Accordingly, the water-detergent mixture, in use, flows from the detergent container 84 along the outlet tube 92 into the flow passage 110 and discharges through the discharge opening 112 in a central region of the brush 62 onto the surface which is cleaned.

The detergent feeding arrangement 80 also includes a detergent flow valve 88 which is installed inline the detergent flow path for permitting a user to control the flow of water through the container 84 to the discharge outlet 112.

In use, if a user desires to utilise the rotary accessory 10, in particular the rotary brush 62, the user connects one end of a garden hose to a pressurised water supply, e.g. a tap, and the outlet end to the domestic garden hose connector 70. The user then opens the valve 72 to allow the feed water to flow through the handle 14 and out of the nozzle 50, the feed water flowing out of the nozzle forming a jet of water.

Impingement of the jet of water on a concave surface of any one of the curved turbine wheel blades 46, in use, results in rotation of the turbine wheel about the turbine wheel rotational axis 22, in the direction of arrow 81. Momentum of the jet of water 76, which is also directed towards the exhaust aperture 36, promotes the dispensing of spent water from the inside of the turbine housing 16 through the exhaust aperture 36, i.e. away from the handle 14. Depending on the load applied to the brush 62 the jet of water will be deflected to a greater or lesser extent. Hence, when a light load is applied to the brush the jet of water will follow the path indicated by arrow 75. When a higher load is applied to the brush the jet of water will follow the path indicated by arrow 74. By adjusting the valve 72 the flow of water and hence the speed of the turbine can be adjusted.

The exhaust water can conveniently be used to wet a surface, while the rotary brush 62 is used to scrub the surface. The exhaust water can also be used to rinse the scrubbed surface.

It is believed that, by directing the water jet outwardly towards the exhaust aperture 36 from a position inwardly of the turbine wheel blades 46, promotes the discharge of spent water, thus relieving a back pressure that can result from accumulated spent water inside the turbine housing 16 and which could lead to stalling of the turbine. Further, directing the exhausted water away from the handle 14 reduces the risk that a person using the accessory 10 will be wet.

The provision of a garden hose connector 70 on the rotary accessory 10, advantageously, facilitates the convenient connection of the rotary accessory 10 to a domestic garden hose.

1. A handheld rotary accessory which includes:
an accessory body;
a water driven turbine mounted on the accessory body; the water driven turbine having a turbine wheel mounted in a turbine housing cavity defined in a turbine housing for rotation about a turbine wheel rotational axis, and having a plurality of circumferentially spaced turbine wheel blades each of which has a radially inner edge and a radially outer edge, the turbine housing further defining an exhaust aperture positioned radially outwardly of the turbine wheel blades; and
a turbine feed water arrangement which includes a feed water inlet which is connectable to a pressurised water supply and a nozzle connected in flow communication with the feed water inlet, the nozzle being positioned radially inwardly of the radially inner edges of the blades.

2. An accessory as claimed in claim 1, in which the nozzle is directed towards the exhaust aperture.

3. An accessory as claimed in claim 2, in which the turbine housing includes two opposite parallel spaced apart major side panels, one major side panel being a circular side panel and the other major side panel being an annular side panel, and a turbine housing edge extending between the radially outer peripheries of the major side panels, the exhaust aperture being defined in the turbine housing edge.

4. An accessory as claimed in claim 3, in which the accessory body includes an elongated handle having a distal end and a proximal end, the water driven turbine being mounted at the distal end of the elongated handle.

5. An accessory as claimed in claim 4, in which the elongated handle is circular cylindrical and has a flow passage extending therethrough for at least part of its length.

6. An accessory as claimed in claim 4, in which the turbine housing is connected to the distal end of the handle, the handle projecting from an outside face of the circular side panel of the turbine housing at an acute angled inclination relative to the outside face of the circular side panel diametrically away from the exhaust aperture.

7. An accessory as claimed in claim 3, in which the turbine housing includes turbine wheel mounting formations for mounting the turbine wheel for rotation about the turbine wheel rotational axis inside the turbine housing, which turbine wheel rotational axis extends between respective centers of the major side panels.

8. An accessory as claimed in claim 7, in which the turbine wheel comprises a turbine wheel shaft and a coaxially located annular turbine wheel back plate, the turbine wheel shaft projecting perpendicularly from the turbine wheel back plate, the turbine wheel shaft being fixedly mounted inside the turbine housing on the wheel mounting formations, the turbine wheel back plate being rotatably mounted on the turbine wheel shaft.

9. An accessory as claimed in claim 8, in which the turbine wheel blades are vanes which project generally perpendicular from one annular face of the turbine wheel back plate, each one of the vanes being curved at a predetermined radius of curvature.

10. An accessory as claimed in claim 8, in which the turbine wheel blades are buckets which are circumferentially arranged in a concentric ring on one annular face of the turbine wheel back plate.

11. An accessory as claimed in claim 8, in which a coupling formation is coaxially fast with the turbine wheel, a free end of the coupling formation projecting past a central opening of the major annular side panel of the turbine housing, the one end of the coupling formation being for engagement with an auxiliary driving arrangement.

12. An accessory as claimed in claim 11, in which the auxiliary driving arrangement includes a drive gear which is provided at a the free end of the coupling formation, and a driven gear which is rotatably mounted on a driven gear support shaft which projects from an outside face of the annular major side panel.

13. An accessory as claimed in claim 12, in which the driven gear includes a utility connection arrangement for connecting a utility accessory for rotation therewith to the driven gear.

14. An accessory as claimed in claim 12, in which the drive gear to driven gear ratio is 1:3.

15. An accessory as claimed in claim 13, in which the utility accessory is a brush comprising a circular brush back plate and bristles extending from one face of the brush back plate, the brush further having brush connection formations for cooperation with the utility connection arrangement of the driven gear.

16. An accessory as claimed in claim 4, in which the feed water inlet is provided at the proximal end of the handle, and is arranged for connection to a water hose which is connectable to the pressurised water supply.

17. An accessory as claimed in claim 4, in which the turbine feed water arrangement include a water conduit for providing the feed water flow path from the feed water inlet to the feed water outlet.

18. An accessory as claimed in claim 4, in which the flow passage which extends through the handle forms part of the water conduit.

19. An accessory as claimed in claim 17, which includes a water control valve in line with the water conduit for permitting a user to control the amount of turbine feed water flowing from the feed water inlet to the nozzle, consequently permitting the user to control the rotational speed of the turbine.

20. An accessory as claimed in claim 15, which includes a detergent feeding arrangement for discharging a detergent onto a surface which is to be cleaned, in use.

21. An accessory as claimed in claim 20, in which the detergent feeding arrangement includes a detergent container defining a detergent cavity, a detergent water inlet, and a detergent discharge outlet.

22. An accessory as claimed in claim 21, in which the detergent container is removably carried on the accessory body.

23. An accessory as claimed in claim 21, in which the detergent water inlet is in fluid communication with the water conduit, for permitting water to flow into the detergent cavity and to mix with the detergent.

24. An accessory as claimed in claim 21, in which the detergent container includes an openable closure member for permitting access to the detergent cavity for refilling the detergent cavity with a detergent.

25. An accessory as claimed in claim 21, in which the detergent container is arranged for receiving a water dissolvable detergent bar, the detergent container being shaped and sized to leave a workable gap between the detergent bar and an inside surface of a longitudinal wall of the container so that water entering the detergent container through the container water inlet flows over the detergent bar, to dissolve part of the detergent to form a detergent-water mixture which flows out of the detergent discharge outlet.

26. An accessory as claimed in claim 21, in which the detergent discharge outlet is provided at the brush.

27. An accessory as claimed in claim 26, in which the driven gear shaft defines a longitudinal shaft cavity having an opening at one end, which opening serves as the detergent discharge opening at the centre of the brush, the shaft cavity being in fluid communication with the detergent container cavity.

28. An accessory as claimed in claim 21, in which the detergent feeding arrangement includes a detergent feed valve which is installed inline the detergent flow path for permitting a user to control the flow of detergent through the detergent discharge outlet.

29. A method of rotatably driving a utility accessory which forms part of a handheld rotary accessory of the type having a water driven turbine drivingly connected to the utility accessory, the turbine being positioned in a housing and having a plurality of circumferentially spaced blades, which method includes discharging water from a nozzle positioned radially inwardly of the turbine blades onto the turbine blades and exhausting water from the housing at a position radially outwardly of the blades.

30. A method as claimed in claim 29 which includes connecting a domestic water supply to a turbine feed water arrangement for supplying feed water to the outward flow turbine for driving the turbine.

31. (canceled)
